(19) United States
(12) Patent Application Publication
(10) Pub. No.: US 2011/0259486 A1
(43) Pub. Date: Oct. 27, 2011

(54) Covers for stationary and mobile tanks

(76) Inventor: Miguel Angel FRANCO HERNANDEZ, Queretaro (MX)

(21) Appl. No.: 12/860,298

(22) Filed: Aug. 20, 2010

(30) Foreign Application Priority Data
Apr. 23, 2010 (MX) MX/A/2010/004468

(51) Int. Cl. B65D 65/02; B23P 11/00

(52) U.S. Cl. 150/154; 29/428

(57) ABSTRACT

A cover or sheath for mobile or stationary tanks for liquids or gases, the tanks being exposed to open air, the cover or sheath comprises a first layer with a first and second face, where the first which is opposite the second face is printed: at least a first opening and a second opening, which serve as locators when the cover is placed on the tank and which allow the entrance and/or the exit of parts to feed or dispense the liquid or gas. The first layer can be a canvas. Alternately, the first layer is a combination of a thermoplastic polymer film and a polyester tissue, and a second layer exists in this embodiment, same which is a synthetic adhesive on the second face of the first layer, where the adhesive is capable of binding the first layer to the tank. A means of closure which runs at least part of the length or width of the cover, is placed on the cover or sheath.

### CROSS-REFERENCE TO RELATED APPLICATIONS

This application claims the benefit under 35 U.S.C. §119 of Mexican Patent Application No. MX/a/2010/004468, filed Apr. 23, 2010, which is hereby incorporated by reference in its entirety.

### FIELD OF INVENTION

The present invention refers to covers or sheaths for tanks which hold liquids or gases, where the tanks are either stationary or mobile, and more specifically to the covers or sheaths for the tanks containing the liquids or gases, where the tanks are stationary or mobile and where the sheath helps protect the tank, the tanks' contents and visually improves the tank.

### BACKGROUND

Both the stationary as well as the mobile tanks are usually crafted of some metal or plastic, depending on the liquid or gas to be contained within it.

For example, in Mexico, it is common that in order to store water, a house is provided with a plastic stationary tank on the upper area of the house, colloquially referred to as the “tinaco” (water tank). Previously, water tanks were made of asbestos. Recently, asbestos use in water tanks has been discontinued and has been substituted for plastic water tanks, usually made of linear polyethylene, usually made of two or three layers of said polyethylene, where at least one exterior layer is black, where said black exterior layer impedes the passage of light into the water tank's interior, in doing so, inhibiting the proliferation of microorganisms inside the water tank. It is possible to have an inner white colored layer, which helps keep the water tank clean and allows one to monitor the water quality in the water tank's interior. The polyethylene water tanks have a long useful life; however they tend to deteriorate eventually due to the effects of rain, environmental contamination, such as carbon dioxide in the atmosphere, excessive dust, acid rain etc. Additionally, said water tanks usually contain additives against ultra violet rays, which however do not always completely block the UV rays, so that the water tank, in addition to the previous, also tends to be deteriorated by the effects of the UV rays upon it. Coupled to the previous, it is common that the water tanks, in light of their exterior layer, visually contrast with the surroundings, given that the outer layer's black coloring stands out in the usual natural color scheme which houses are commonly painted.

On the other hand, stationary metal tanks are subject to environmental weathering. The metal selected is usually steel, brass, aluminum, copper, tin, zinc, bronze, iron, where all these metals are subject to corrosion. For example, in areas of high salinity, such as places close to beaches, the metallic tanks are corroded in short periods of time. Additionally, the above mentioned metals in low salinity areas are subject to similar deterioration to that of plastic tanks, that is, the previously mentioned water tank. Also, this type of tank is usually placed on the upper area of homes making them visible and disturbing the design of its surroundings.

The mobile tanks, such as pressure tanks, cylinders or gas carafes are the system commonly used for butane, propane and other gas distribution to the retail market. The mobile tanks, by virtue of being mobile, are subject to the same weathering previously described for the water and gas stationary tanks, coupled to the deterioration caused by the knocks received during its transportation.

Most of the improvements made in this area have been made focusing directly on the tanks themselves and not in the aids to said tanks. However, some improvements have been made to the tanks in the area of their supports, such as is the case in the French patent No. 2 734 042 which describes a cover to protect a gas cistern intended to be buried underground, which comprises a tubular body mounted on a removable part, where the tubular body is made from a synthetic thermoplastic material which is extruded and/or molded.

However, previous art does not show a cover or sheath specifically crafted for stationary or mobile tanks, for liquid or gas, which helps protect a tank from weathering and deterioration due to the environment, which blocks UV rays, maintains a temperature of the liquid or gas within, which at the same time contributes to a positive image among its surroundings as well as enables it for possible advertisement purposes.

### BRIEF DESCRIPTION OF THE INVENTION

The present invention refers to a cover or sheath for stationary or mobile tanks which are in contact with the environment, specifically in open air, tanks which typically receive, hold and dispense a liquid or gas. The cover or sheath are only referred to as cover, comprises two main embodiments.

The first embodiment is a cover made of canvas which is easily assembled to and disassembled from the tank and on which can be printed unto, while the second embodiment is a cover made of a material which can easily be printed on one side and on whose other side can adhere to the tank.

In terms of the second embodiment, a cover with at least two layers is provided, preferably three layers, where the first layer of the outer layer is a polyvinyl chloride (PVC) film in combination with a polyester tissue. A second layer of the second embodiment is a synthetic adhesive preferably an acrylic type, even when other adhesives, such as a cyanoacrylate, epoxy or urethane can be used. The acrylic adhesive kind is the best adhesive for the application, since acrylic type adhesive has a good means of adhering to linear polyethylene surfaces, as well as to metallic surfaces. Finally, a third layer can be placed in the second embodiment which is a silicone paper, preferably the kraft type paper with silicon, which allows the adhesive between layers to not dry out before the securing of the cover to the tank takes place, that the cover not attract dust on the adhesive side and lastly, that the cover not stick unto undesired objects and thus lose its adhesive quality. The previous second embodiment shall be referred to as the adhesive vinyl from here on out.

The cover, that is, the canvas or adhesive vinyl is comprised of at least two openings which function partly as locators and at the same time allow the entrance and exit of parts to feed or dispense the material contained within the tank. The openings can be found in different positions depending on the tank, for example, in the case of a water tank, at least two openings are found on the cover, a first opening on the upper part and a second opening on the lower side, where the first opening allows access to the water tank's filling tubes and where the second opening allows the passage of the material dispensing tubes inside the water tank. In the case of a stationary gas tank, there are at least two openings on the cover, where a first opening for the crest of the tank, same which in a different embodiment can be covered by the cover, and a second opening for the tank's support or feet. At least one opening can also be present per each of the tank's handles, should the tank have such. In the case of a mobile tank, there can be at least one opening on the cover, where the first opening is designed for the tank's crest where it shall be connected to a pressure regulator and a hose; optionally, the mobile tank can consist of two openings, a first one as previously intended and a second on the tank's lower part, that is in the tank's base to help avoid deterioration to the lower part of the cover. Additionally, the cover is provided with a means of closure and opening, particularly in the case of the first embodiment, such as a metallic zipper fastener, a plastic zipper fastener, grasping hooks and buckles, buttons or means of closure and opening similar to those known in the art. The means of closure and aperture allow for the ease of the cover's opening and closing. The means of closure and aperture can run the entire length of the cover's height. Alternately, the means of closure and aperture can run the entire length of the cover's width. Alternately, the means of closure and aperture can run any partial length of the cover's height or width. It is preferred that the partial length be at least half of the cover's height or width measurement.

Thus, it is the objective of the present invention to provide and employ a cover for stationary and mobile gas or liquid tanks, which helps protect the tank from weathering and deterioration to the environment, such as environmental contamination, such as carbon dioxide in the atmosphere, salinity, excess of dust particles, acid rain etc. thus helping maintain the material contained within the tank in its natural state.

It is another objective of the present invention to provide and use a cover for stationary and mobile liquid or gas tanks, which aid in the tank's protection against the damage caused by UV rays, thus prolonging the tank's life.

It is yet another objective of the present invention to provide and use a cover for stationary and mobile tanks which is capable of maintaining a constant temperature of the material being stored within the tank.

Another objective of the present invention is to provide and use a cover for stationary and mobile tanks which help raise the water's temperature in the water tank, so that, when hot water is used, the water may reach the heater at a certain determined temperature and waste less gas.

It is another objective of the present invention to provide and use a cover for stationary and mobile tanks which contributes to the aesthetic design of a city's surroundings and/or which allows it to be used for advertisement purposes.

In a similar fashion, it is an objective of the present invention for the methods of installation of the sheaths to the various mobile or stationary tanks with the previously mentioned covers or sheaths.

Other objectives and advantages of the present invention shall become apparent when the description reference is taken into account in conjunction with the following drawings.

### BRIEF DESCRIPTION OF THE DRAWINGS

The particular advantages and characteristics of the invention, as well as other objectives of the present invention, shall become apparent from the following description, understood in conjunction with the accompanying drawings, which:

FIG. 1 is a frontal view of a first stationary tank with the cover of the present invention.

FIG. 2 is a frontal view of a second stationary tank with the cover of the present invention.

FIG. 3 is a frontal view of the mobile tanks with the cover of the present invention.

FIG. 4 is a cross section view of the cover of the second embodiment of the present invention.

FIG. 5 is a frontal view of the mobile tanks with the cover of the present invention.

FIG. 6 is a flow diagram of the method of elaboration of the first embodiment of covers of the present invention.

### DETAILED DESCRIPTION OF THE INVENTION

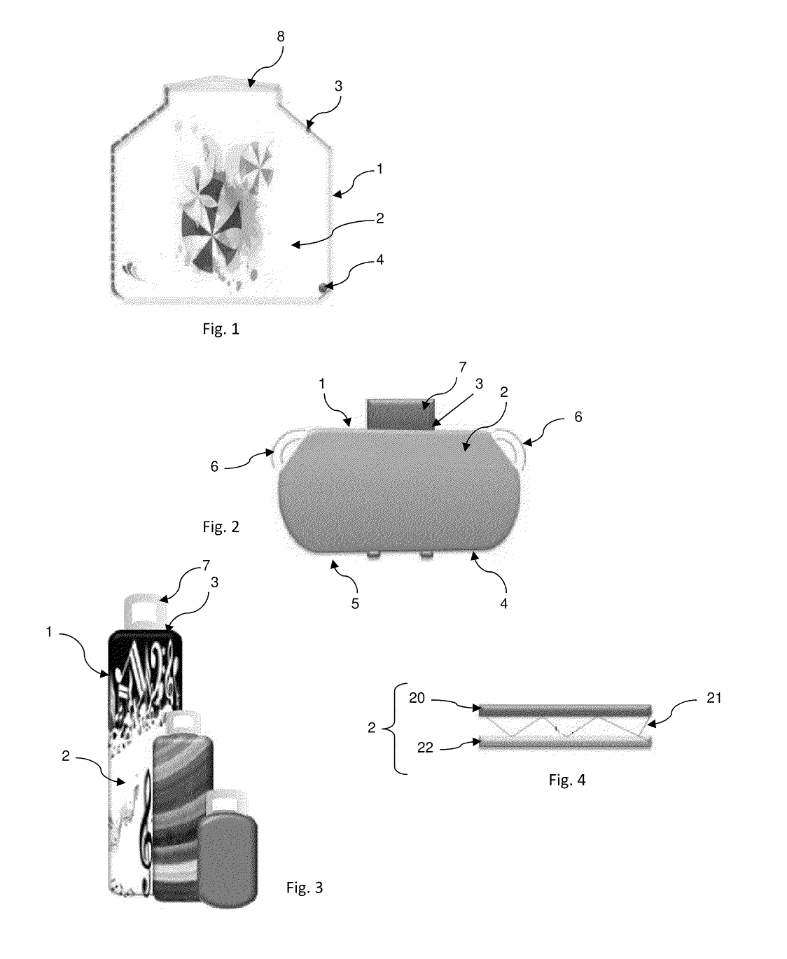

Just as shown in FIGS. 1 thru 3, the present invention is formatted as a cover 2 for tanks 1 which can either be stationary or mobile, where the stationary or mobile tanks are capable of receiving, storing and administering liquids or gases and where the stationary or mobile tanks 1 are exposed to the open air. Specially, it is conceived for the stationary or mobile tanks 1 which are at a visual point either of the operator or third parties.

The present invention can be divided into two main embodiments.

### First Embodiment

The cover refers to a one single layer, called the first layer 20, which is a canvas. More detail of this first embodiment will be given in the general details of the description or other embodiments.

### Second Embodiment

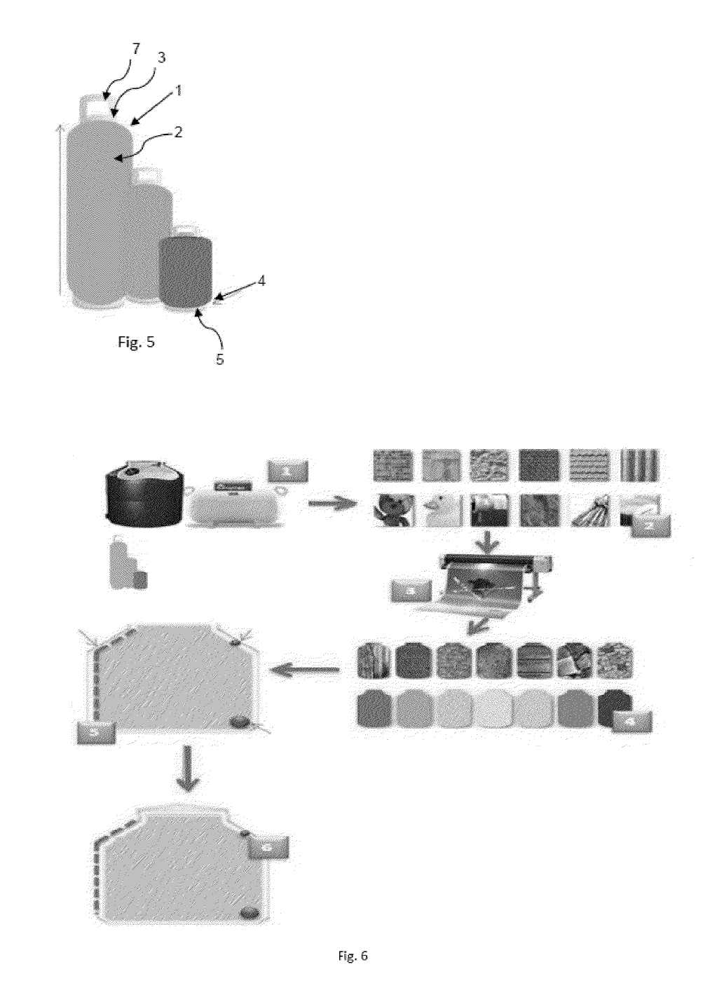

The cover comprises at least two distinct layers and preferably at least three layers. Such as is shown in FIG. 4, the cover of the second embodiment is constituted by at least two layers 20, 21, where the first layer 20 can be easily imprinted on one side and by a second layer 21 which allows for easy adhesion to the tank 1. So that the outer layer is comprised of at least two layers 20, 21, but can however be comprised of at least three layers 22.

The cover's first layer 20 of the second embodiment is a combination of a thermoplastic polymer film, where the preferred thermoplastic is polyvinyl chloride (PVC) and a polyester tissue. It is specially required that the PVC be flexible and soft, thus plasticizers are necessary. The preferred plasticizers for the PVC are phthalates, which give the PVC the desired flexibility and durability, as well as give the PVC a good amount of water resistance as well as to oils, protecting the cover from water and oils. Among the preferred phthalates are: Di(2-ethylhexyl)phthalate, Butylbenzylphthlate, Di-n-butylphthlate, Di(n-octyl)phthalate, Diisononylphthlate, Diisodecylphthlate, Diethylphthlate, Diisobutylphthlate, Di-n-hexylphthlate or mixes of the same. This addition of the plasticizers is necessary to the PVC because the first layer 20 must be a flexible film, capable of resisting the environment. The percentage between the thermoplastic polymer and the polyester tissue varies between 20% and 35% of polyester tissue and varies between 65% and 80% of the thermoplastic polymer, preferably between 25% and 30% of the polyester tissue and 70% to 75% of the thermoplastic polymer and even more preferably, approximately 29% of the polyester tissue and 71% of the thermoplastic polymer. This combination between the polyester tissue and the thermoplastic polymer allows the cover 2 a resistance action to the wind and a resistance action to fire. In similar fashion, other properties, such as the ability to maintain temperature of the inner materials and additionally, to increase temperatures, may be possible.

A second layer 21 of the cover of the second embodiment is a synthetic adhesive, preferably an acrylic type, even when other types of adhesives, such as cyanoacrylate, epoxy or urethane can be used. The acrylic adhesive kind is the best adhesive for the application, since acrylic type adhesive has a good means of adhering to linear polyethylene surfaces, as is the case in water tanks as well as metallic surfaces. In the same way, the acrylic type adhesive has a good adhesion quality with the first layer 20 of the mixture of the polyester tissue and the thermoplastic polymer. It is preferred that the second layer 21 have a medium to medium high viscosity at a temperature matching its surrounding, as well as having UV ray resistance. Thus, opaqueness similar to that of the first layer 20, which shall be described later, is required for the second layer. The thickness of the second layer 21 should vary between 0.16 to 0.26 mm, and more preferably between 0.18 to 0.20 mm, and even more preferably a thickness of 0.20 mm.

Finally, a third layer is optional 22 for the cover in the second embodiment, which is a silicon paper, preferably a kraft type silicon paper, which allows the second layer 21 to not dry out before the securing of the cover 2 to the tank 1 takes place, as well as ensuring that the cover 2 not attract dust on the adhesive layer 21 and lastly, that the cover 2 not stick unto undesired objects and thus lose its adhesive quality. The thickness of the third layer 22 shall be similar to that of the first layer 20 which is mentioned below.

### General Dispositions and Other Embodiments

It is preferred that the first layer 20 have a thickness varying between 0.08 mm to 0.13 mm, more preferably between 0.09 mm to 0.10 mm and even more preferably, a thickness of 0.10 mm. It is preferred that the first outer layer 20 have a weigh varying between 135 to 150 g/m2, more preferably between 140 to 145 g/m2, and even more preferably, a weight of approximately 140 g/m2. It is preferred that the first layer have a reduction greater than approximately 0.9%. It is preferred that the first layer have a brightness varying between 45 and 60, more preferably between 50 and 55 and even more preferably, a shine of 50. The opaqueness of the first layer is preferred to be between 80 and 90%, more preferably 80% opaqueness. The first layer 20 allows the ink form the print be anchored to said coat, thus allowing for a brilliance in the print, long lasting and with good color reproduction.

The preferred ink for the application is the Eco-Ultra® used in printers such as Mimaki, Rolando, Graphtech and Mutoh, among others. However, other brands of ink, such as Inkwell® may be used.

Such as can be seen in FIGS. 1 thru 3 and 5, the cover comprises at least two openings 3, 4 which function in part as locators as well as allow the entrance and exit of parts to feed or dispense the material (whether liquid or gas) within the tank 1. The openings 3, 4 can be located in different positions depending on the tank 1; for example, in the case of the water tank as shown in FIG. 1, it consists of at least two openings 3, 4 on the cover, a first opening 3 on the upper part and a second opening 4 on the lower part, where the first opening 3 allows the passage of the tubing which feeds the water tank and where the second opening 4 allows the passage of the tubing which dispenses the material within the water tank. In the case of the stationary water tank 1 shown in FIG. 1, it can have at least a third opening for the proper opening and closing of the water tank's cover 8. Similarly, the same stationary tank 1, can have at least a fourth opening in the lower part to allow for the proper seating of the tank 1 directly onto the surface to be seated on. In the case of a stationary tank gas, such as is shown in FIG. 2, at least two openings are present 3, 4 on the cover, a first opening 3, on the tank's crest 7, same which in an embodiment, said crest 7 can be covered by the cover 2, and a second opening 4 for the tank's base or feet 5. At least a third and fourth opening can be present for the tank's handle 6, should the tank 1 have one. In the case of a mobile tank, at least a first opening 3 is present on the cover 2, where the first opening 2 is meant for the crest 7 of the mobile tank 1, and where a pressure regulator and a hose shall be connected; optionally, the mobile tank 1, can have two openings 3, 4, a first opening present for the crest 7, and a second opening 4 on the lower part of the tank 1, that is to say, on the tank's base 5, to avoid deterioration to the cover's 2 lower part.

Additionally, the cover 2 is provided with a means of aperture and closure 9, especially in the case of the first embodiment; however, the second embodiment can also contain said means of aperture and closure 9. Said means of aperture and closure such as a metallic zipper fastener, a plastic zipper fastener, grasping hooks and buckles, buttons or means of closure and opening similar to those known in the art. The means of closure and aperture 9 allow for the ease of the cover's 2 opening and closing. The means of closure and aperture 9 can run the entire length of the cover's 2 height. Alternately, the means of closure and aperture 9 can run the entire length of the cover's 2 width. Alternately, the means of closure and aperture 9 can run any partial length of the cover's 2 height or width. It is preferred that the partial length be at least half that of the cover's 2 height or width measurement. It is preferred that the means of closure and aperture 9 be on the opposite side or is at least removed from the openings 3, 4. The distance between these two, the openings 3, 4 and the means of closure and aperture 9, shall be the least possible to allow for proper installation of the cover 2.

FIG. 6 shows a diagram of the flow of the elaboration process of the cover 2 in the first embodiment. Initially, step 1, a tank 1 is chosen, to be covered. Once the tank 1 is selected, step 2 involves the selection of design type. The design is imprinted on a first side of the first layer 20. To this first printed layer 20, and in particular case of the second embodiment, the second layer 21 is added on the opposite side to the printed side of the first layer 20. Optionally, in the particular case of the third embodiment, a third layer 22 is added to the second layer 21, leaving the second layer 21 between the first 20 and third layers 22. Later, the form of the tank 1 selected is given to the cover 2. In similar fashion, to this step is added the means of aperture and closure 9 to the cover 2 with the appropriate form of tank 1 selected, if it applies, specifically, the means of necessary aperture and closure 9 are added to the first embodiment and optionally to the second embodiment. This means of addition may be via the tissue of the means of the cover's 2 aperture and closure 9. Finally, in the same step, the necessary cuts are taken to provide the cover with at least two openings 3, 4. The size of the cuts depends on the tank 1 to be covered.

The process of placement of the cover 2 in the first embodiment refers to the placement of the cover 2 on the tank 1; where the openings 3, 4 are taken as reference/locating points to place the canvas. Specifically, the cover 2 is placed with the openings 3, 4 set as a parting point towards opposite extremes. Depending on the location of the means of aperture and closure 9, the cover 2 is closed either in a horizontal or vertical way.

The process of placement of the cover 2 in the second embodiment refers to the surface cleaning of the tank 1, to eliminate the dirt and dust gathered on the tank 1. If the cover comprises a third layer 22, the third layer 22 is detached from the first 20 and second layer 22. The cover's second layer 21 is placed on the tank 1, taking the openings 3, 4 as locating points in order to place the cover. Pressure is applied on the cover against the tank by means of a rubber spatula, sliding said spatula between the cover starting from the center unto the outer side, thus eliminating the air bubbles formed during the cover's placement. It is closed by means of aperture and closure 9 means, if such is present, ensuring that through the openings 3, 4, the proper passage of tubing or similar take place. Finally, the cover 2 is protected during two days against possible environmental events, such as rain, so that the cover 2 may have better performance.

Alterations to the structure described in the present, can be made by those deemed experts in the field. However, it must be understood, that the present description is related with the preferred embodiments of the invention, which is merely for illustrative purposes only, and shall not be construed as a limitation to the invention. All modifications which do not depart from the spirit of the invention shall be included within the body of the attached claims.

What is claimed is:

1. A cover or sheath for mobile or stationary tanks for liquids or gases, the tanks being exposed to open air, the cover or sheath comprising:
a first layer with a first and second face opposite to the first face, where the first face is imprinted; and
at least a first opening and a second opening on the first layer, which locate the cover during the cover's installation on the tank and which allow the entrance and/or exit of parts to feed or dispense the liquid or gas.

2. The cover or sheath according to claim 1, wherein the first layer is a canvas.

3. The cover or sheath according to claim 2, wherein the cover additionally comprises a means of closure which runs at least part of the length or width of the cover and which is distant from said at least a first opening and a second opening on the first layer.

4. The cover or sheath according to claim 1, wherein a first layer combines a film of a thermoplastic polymer and a polyester tissue, and where the cover additionally comprises a second layer of the synthetic adhesive of the second face of the first layer, and where the adhesive is capable of attaching the first layer onto the tank.

5. The cover or sheath according to claim 4, wherein the sheath or closure consists of a third layer which is a silicone paper, preferably a kraft type paper.

6. The cover or sheath according to claim 4, wherein the thermoplastic polymer is a polyvinyl chloride which contains plasticizers, preferably phthalates selected among di(2-ethylhexyl)phthalate, butylbenzylphthlate, di-n-butylphthlate, di(n-octyl)phthalate, diisononylphthlate, diisodecylphthlate, diethylphthlate, diisobutylphthlate, di-n-hexylphthlate or mixes of the same.

7. The cover or sheath according to claim 4, wherein the percentage between the thermoplastic polymer and the polyester lies between 20% polyester and 80% thermoplastic polymer, more preferably between 25% polyester and 75% thermoplastic polymer, and even more preferably, 29% polyester and 71% thermoplastic polymer.

8. The cover or sheath according to claim 4, wherein the synthetic adhesive is an acrylic adhesive with a medium high viscosity at a temperature comparable to its surroundings and resistance to UV rays, with an 80 to 90% opaqueness, more preferably approximately 80% and a thickness varying between 0.16 to 0.26 mm, more preferably between 0.18 to 0.20 mm and even more preferably, approximately 0.20 mm.

9. The cover or sheath according to claim 4, wherein the cover additionally comprises a means of closure which runs at least part of the cover's length or width and which is distant from said at least first opening and a second opening on the first layer.

10. The cover or sheath according to claim 1, wherein the first layer has a thickness varying between 0.08 to 0.13 mm, more preferably one between 0.09 and 0.10 mm and even more preferably, one of 0.10 mm, a weight of 135 to 150 g/m2, more preferably between 140 to 145 g/m2 and even more preferably one of 140 g/m2, a reduction greater than approximately 0.9%, a brightness varying between 45 and 60, more preferably between 50 and 55 and even more preferably, one of 50, an opaqueness varying between 80 and 90%, more preferably approximately 80%.

11. The cover or sheath according to claim 1, wherein the ink is the Eco-Ultra® brand.

12. The cover or sheath according to claim 1, wherein the first opening is in the upper part and the second opening is on the lower side, and where the first opening allows the passage of tubing for feeding and where the second opening allows the passage of tubing for dispensing of the liquid or gas.

13. The cover or sheath according to claim 12, wherein the cover or sheath comprises a third opening for the opening and closing of a cover of the tank.

14. The cover or sheath according to claim 12, wherein the cover or sheath comprises of a fourth opening for the lower part of the tank, which allows for the proper seating of the tank.

15. The cover or sheath according to claim 1, wherein the first opening is for a crest of the tank, the second opening is for the base or feet of the tank, a third opening for a first handle of the tank and a fourth opening for a second handle of the tank.

16. The cover or sheath according to claim 15, wherein the crest of the tank is covered by the cover.

17. The cover or sheath according to claim 1, wherein the first opening is for a crest of the tank and the second opening is for the base of the tank.

18. The cover or sheath according to claim 1, wherein the first layer maintains a constant temperature of the liquid or the gas within the tank.

19. The cover or sheath according to claim 1, wherein the first level raises the temperature of the liquid or gas within the tank.

20. The cover or sheath according to claim 3, wherein the means of closure or aperture is a zipper fastener, where the zipper fastener runs the entire length of the cover's height, or runs the entire length of the cover's width or runs at least half the length of the cover's height or the width.

21. A method for creating or installing a sheath or cover of claim 1 on a mobile or stationary tank for liquids or gases, which is exposed to open air, the method comprises:
selecting one type of tank;
printing a design on a first side of a first layer of the cover or sheath;
form the cover or sheath according to the shape of the tank selected; and
placing the cover on the tank, taking a first and second opening on the first layer as locating points in order to place the cover on the tank.

22. The method according to claim 21, wherein previous to the step placing the cover on the tank, a step involving the cleaning of the cover's surface eliminating dirt and accumulated dust on the tank takes place.

23. The method according to claim 21, wherein during the step of forming the sheath or cover, a step involving adding a means of aperture and closure and where after the step involving placing the cover on the tank, the step of closing the means of aperture and closure takes place.

24. The method according to claim 21, wherein additionally the step of adding a second side to the first layer opposite to the first side of the first layer, a second layer with an synthetic adhesive; and wherein after the step of placing the cover on the tank, the step of pressing the first layer against the tank, sliding said pressure from the center of the tank outwards to the tank's extremes takes place and the step to protect the cover for at least two days from atmospheric events.

25. The method according to claim 24, wherein on the side of the second face, a second layer has a third layer added unto it of silicon paper, preferably the paper is a kraft type paper, and where prior to the placing of the second layer unto the tank, the third layer is detached from the first and second layers.
